(19) United States
(12) Patent Application Publication
(10) Pub. No.: US 2002/0114036 A1
(43) Pub. Date: Aug. 22, 2002

(54) Optical switching in dense wavelength division multiplexing (DWDM) fiber access nodes

(76) Inventor: Nasir Ghani, La Jolla, CA (US)

Correspondence Address: Lee Hsu, Brobeck, Phleger & Harrison LLP, 12390 El Camino Real, San Diego, CA, 92130-2081, US

(21) Appl. No.: 09/792,786

(22) Filed: Feb. 22, 2001

(51) Int. Cl. H04J 14/02

(52) U.S. Cl. 359/128; 359/124

(57) ABSTRACT

An optical switching system which includes an optical switch matrix for communications between internet protocol (IP) routers in a dense wavelength division multiplexing (DWDM) optical network allows available wavelengths to be dynamically assigned to the IP routers for inbound or outbound traffic, with partial or full wavelength translation.

### BACKGROUND OF THE INVENTION

1. Field of the Invention

The present invention relates to optical networks, and the more particularly, to dense wavelength division multiplexing (DWDM) optical networks.

2. Background

Optical wavelength division multiplexing (WDM) systems have been implemented in various types of communications networks including those implemented for carrying internet traffic. A conventional optical WDM network typically allows “edge” electronic devices to be connected seamlessly among each other, thereby extending the reach of the network over great distances. A conventional optical network with dense wavelength division multiplexing (DWDM) capability allows multiple optical channels to be carried by densely spaced optical wavelengths within a relatively narrow spectrum, for example, within an infrared spectrum around 1550 nm. Dense wavelength division multiplexing at optical wavelengths has been realized with the emergence of wavelength routing devices, including optical cross-connects (OXCs) and optical add-drop multiplexers (O-ADMs).

In order to be connected to optical wavelength routing networks, many electronic “edge” devices typically go through an “edge” fiber access system, in which optical signals are multiplexed and then demultiplexed onto optical fibers that connect to wavelength routing devices, such as optical cross-connects and optical add-drop multiplexers. Single-wavelength lasers are modulated by electronic signals and then multiplexed together in a network node to form a DWDM signal, which is routed through the wavelength routing network to another node, which demultiplexes and then demodulates the optical signals.

FIG. 1 shows a diagram of a typical example of a conventional WDM optical network with fixed wavelength associations. In this example, two internet protocol (IP) routers 2 and 4 are connected to a first optical network node 6, and two IP routers 8 and 10 are connected to a second optical network node 12. Each of the IP routers has separate input and output connections to the respective optical network node. In a typical example, each optical network node is provided with a wideband receiver for each of the inbound and outbound signal paths to each of the IP routers. For example, for the first IP router 2, a wideband receiver 14 and a fixed wavelength laser modulator 16 are connected to the outbound optical path 18 while a wideband receiver 20 is connected to the inbound optical path 24. The outbound optical path 18 from the first IP router 2 is assigned a predetermined fixed wavelength λ₁ while the inbound optical path 24 is assigned another predetermined fixed wavelength λ₂. In a similar manner, the inbound and outbound optical paths 26 and 28 for the second IP router 4 are assigned predetermined fixed wavelengths λ₃ and λ₄, respectively.

The third and the fourth IP routers 8 and 10, which are connected to the second optical network node 12, are also assigned fixed predetermined wavelengths for the inbound and outbound optical paths. In the configuration shown in FIG. 1, the inbound optical path 30 to the third IP router 8 is assigned wavelength λ₁ while the outbound optical path 32 is assigned wavelength λ₂. Similarly, the outbound optical path 34 from the fourth IP router 10 is assigned wavelength λ₃ while the inbound optical path 36 is assigned wavelength λ₄. In this configuration, wavelength λ₁ is assigned to carry internet traffic from the IP router 2 to the IP router 8, while wavelength λ₂ is assigned to carry internet traffic unidirectionally from the IP router 8 to the IP router 2. In a similar manner, wavelengths λ₃ is assigned to carry internet traffic unidirectionally from the IP router 10 to the IP router 4, while wavelengths λ₄ is assigned to carry internet traffic unidirectionally from the IP router 4 to the IP router 10.

The optical networking configuration as shown in FIG. 1 with static wavelength assignments is highly inflexible and severely restricts network wavelength routing algorithms. For example, even if a physical optical channel is available from an ingress optical network node to an egress optical network node, it may not be possible for the edge fiber access device to utilize this optical channel because the wavelength for this optical channel cannot be reassigned. The lack of flexibility in this configuration may result in scenarios in which some of the available wavelengths are wasted while demands for bandwidths by other edge fiber access devices in the network are not being satisfied.

In order to increase the flexibility of wavelength assignments in an optical DWDM network, another networking scheme has been proposed in which multiple ports on a given IP router are connected to multiple ports of an optical network node with multiple fixed wavelength associations. An example of such a scheme is shown in FIG. 2, in which each of the IP routers has two inbound and two outbound fixed wavelengths associations. For example, the IP router 40 has two outbound optical paths 42 and 46 which are assigned fixed predetermined wavelengths λ₁ and λ₃, respectively, and two inbound optical paths 48 and 50 which are assigned fixed predetermined wavelengths λ₂ and λ₄, respectively.

In a similar manner, the IP router 52 has two inbound optical paths 54 and 56 which are assigned fixed wavelengths λ₅ and λ₇, respectively, and two outbound optical paths 58 and 60 which are assigned fixed wavelengths λ₆ and λ₈, respectively. Although this configuration with multiple fixed wavelength associations for each IP router allows inbound and outbound internet traffic to be carried by multiple wavelengths, a limitation still exists as to which wavelengths the edge fiber access devices can transmit due to restricted physical port connectivity. Furthermore, multiple optical connection ports are required for each IP router, thereby increasing bandwidth costs and most likely reducing resource utilization for network service providers.

Therefore, there is a need for an optical network which is capable of achieving better utilization of optical wavelengths for internet traffic with increased flexibility.

### SUMMARY OF THE INVENTION

The present invention provides an optical switching system with dynamic partial wavelength translation or dynamic full wavelength translation. An embodiment of the system with dynamic partial wavelength translation generally comprises:

a plurality of input optical channels capable of receiving optical signals carrying internet traffic;

a plurality of output optical channels capable of transmitting optical signals carrying internet traffic;

an optical switch matrix having first and second pluralities of input ports and first and second pluralities of output ports, the first plurality of input ports connected to the input optical channels, the first plurality of output ports connected to the output optical channels;

a plurality of receive-transmit laser modules connected to the second plurality of output ports of the optical switch matrix; and

a wavelength multiplexer having a multiple-wavelength port and first and second pluralities of single-wavelength ports, the first plurality of single-wavelength ports connected to the outbound receive-transmit laser modules, the second plurality of single-wavelength ports connected to the second plurality of input ports of the optical switch matrix.

An embodiment of the system with dynamic full wavelength translation generally comprises:

a first plurality of optical channels capable of transporting optical signals carrying internet traffic;

a plurality of inbound wideband receivers;

an optical switch matrix having first and second pluralities of ports;

a first plurality of optical switches capable of connecting the first plurality of ports of the optical switch matrix to the first plurality of optical channels respectively through the inbound wideband receivers;

a second plurality of optical channels capable of transporting optical signals carrying internet traffic;

a plurality of receive-transmit laser modules;

a second plurality of optical switches capable of connecting the second plurality of ports of the optical switch matrix to the second plurality of optical channels respectively through the receive-transmit laser modules; and

a wavelength multiplexer having a multiple-wavelength port and a plurality of single-wavelength ports, the single-wavelength ports connected to the second plurality of optical channels.

Advantageously, the optical switching system according to embodiments of the present invention allows the optical network to dynamically translate and select the wavelengths at which client signals carrying internet traffic are inserted into and extracted from the optical network. Furthermore, the optical switching system according to embodiments of the present invention is capable of providing a high degree of flexibility in wavelength assignments for internet traffic between multiple IP routers with a great degree of transparency, thereby improving the scalability of the optical network.

### BRIEF DESCRIPTION OF THE DRAWINGS

The present invention will be described with particular embodiments thereof, and references will be made to the drawings in which:

FIG. 1 described above, shows an example of a conventional DWDM optical network with fixed wavelength associations;

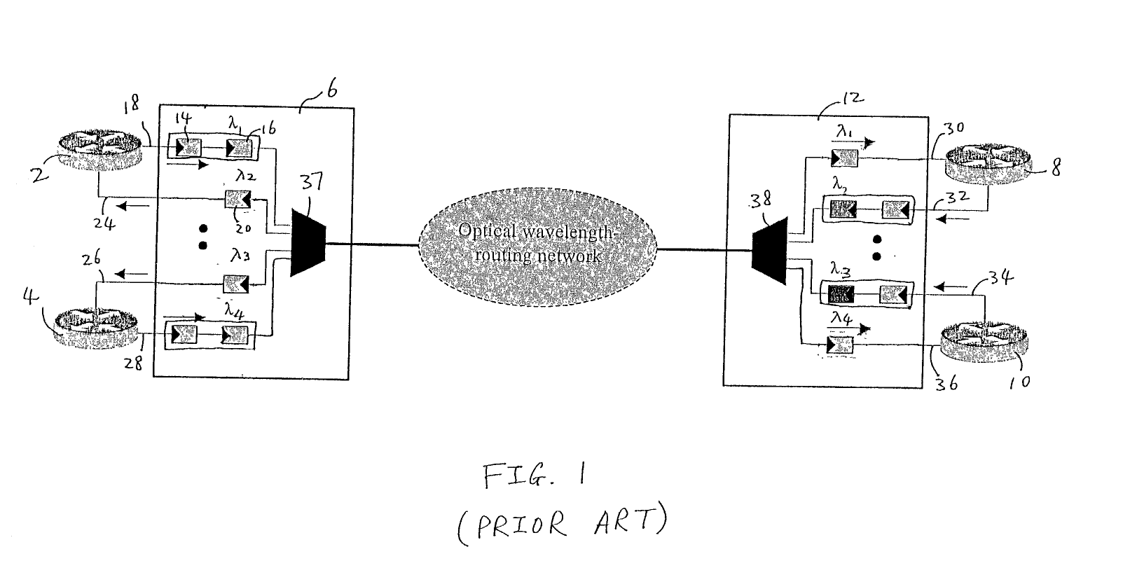

FIG. 2 described above, shows another example of a conventional DWDM optical network with multiple fixed wavelength associations; and

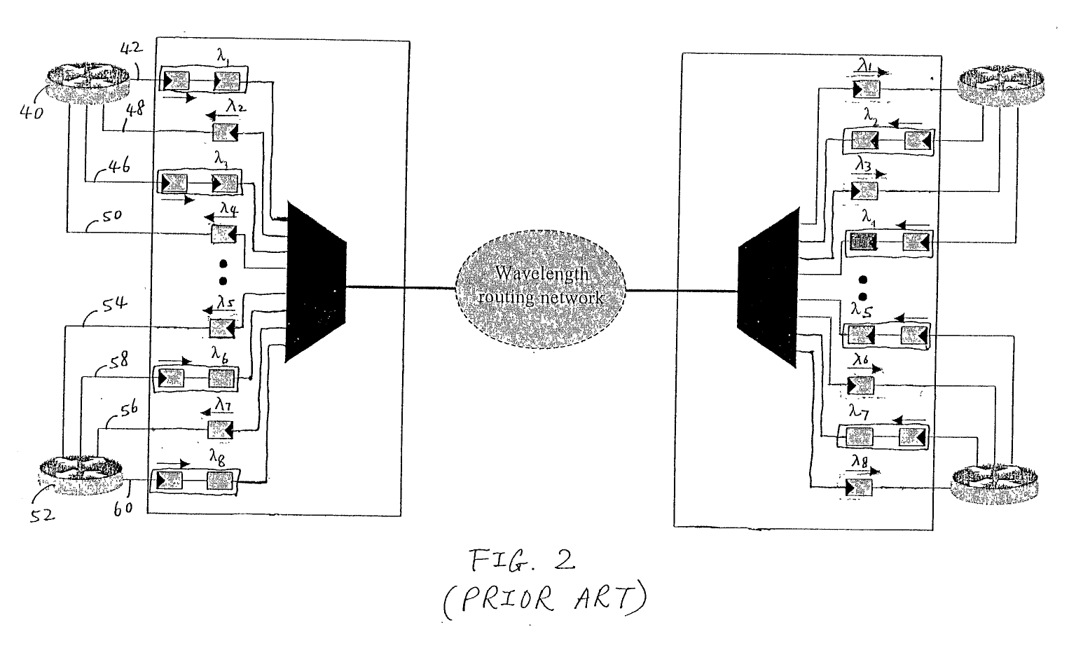

FIG. 3 shows a DWDM optical network node which includes an optical switch matrix for partial wavelength translation in an embodiment according to the present invention;

FIG. 4 shows a DWDM optical network which includes two DWDM network nodes of FIG. 3 with partial wavelength translation in an embodiment according to the present invention;

FIG. 5 shows a DWDM optical network node which includes an optical switch matrix for full wavelength translation in an embodiment according to the present invention; and

FIG. 6 shows a DWDM optical network which includes two DWDM optical network nodes of FIG. 5 with full wavelength translation in an embodiment according to the present invention.

### DETAILED DESCRIPTION

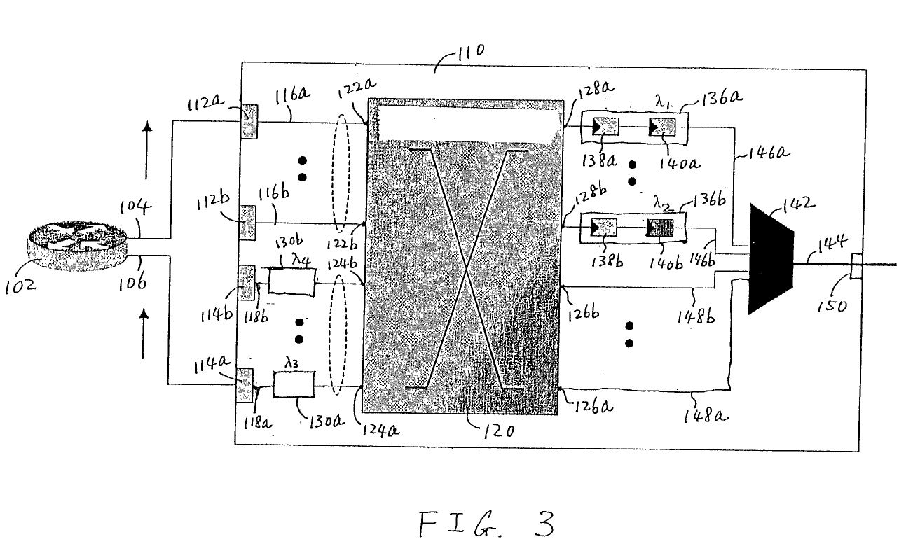

FIG. 3 shows a dense wavelength division multiplexing (DWDM) optical switching node in an optical network with partial wavelength translation in an embodiment according to the present invention. An internet protocol (IP) router 102 has an output port 104 and an input port 106 which are connected to the DWDM optical switching node 110 through an input optical interface 112a and an output optical interface 114a, respectively. The DWDM optical switching node 110 has a plurality of input optical channels including input optical channels 116a and 116b which are capable of receiving wideband optical signals carrying internet traffic from different IP routers. FIG. 3 shows two input optical interfaces 112a and 112b connected to the input optical channels 116a and 116b, respectively, for receiving wideband optical signals from IP routers.

A plurality of output optical channels 118a and 118b are also provided in the DWDM optical switching node 110 to transmit wideband optical signals carrying internet traffic to the IP routers. A plurality of output optical interfaces 114a and 114b are connected to the output optical channels 118a and 118b, respectively. In this embodiment, each IP router is connected to a respective input optical port and a respective output optical port through two separate optical fibers, and internet traffic flows in a single direction in each of the fibers. The optical interfaces 112a and 114a are connected to the IP router 102, while the optical interfaces 112b and 114b can be connected to another IP router (not shown in FIG. 3). In an embodiment, the input and output optical interfaces 112a, 112b, 114a and 114b are conventional wideband International Telecommunications Union-Telecommunication Standardization Sector (ITU-T) interfaces at wavelengths on the order of about 1310 nm.

In an embodiment, the DWDM optical switching node 110 comprises a W×W optical switch matrix 120, wherein W is the number of wavelengths multiplexed and demultiplexed by the optical switching node 110. The optical switch matrix 120 has a plurality of optical ports which are grouped into a first plurality of input ports including input ports 122a and 122b, a first plurality of output ports including output ports 124a and 124b, a second plurality of input ports including input ports 126a and 126b, and a second plurality of output ports including output ports 128a and 128b. The first plurality of input ports 122a and 122b are connected to the input optical channels 116a and 116b, respectively, while the first plurality of output ports 124a and 124b are connected to the output optical channels 118a and 118b, respectively.

In an embodiment, a plurality of wideband receivers 130a and 130b are connected between the output ports 124a and 124b of the optical switch matrix 120 and the output optical interfaces 114a and 114b along the output optical channels 118a and 118b, respectively. The wideband receivers 130a and 130b are assigned predetermined wavelengths λ₃ and λ₄, respectively. In an embodiment, the wideband receivers 130a and 130b receive the optical signals from the optical switch matrix 120 by perform optical-to-electronic signal conversions. Alternatively, the wideband receivers 130a and 130b are capable of optical-to-optical receive-transmit operations without optical-to-electronic and electronic-to-optical signal conversions.

In an embodiment, a plurality of receive-transmit laser modules 136a and 136b are connected to the second plurality of output ports 128a and 128b of the optical switch matrix 120, respectively. In an embodiment, each of the receive-transmit laser modules comprises a wideband receiver connected to a respective one of the second plurality of output ports of the optical switch matrix 120 and a fixed wavelength laser modulator connected to the wideband receiver. For example, the receive-transmit laser module 136a comprises a wideband receiver 138a and a fixed wavelength laser modulator 140a, while the receive-transmit laser module 136b comprises a wideband receiver 138b and a fixed wavelength laser modulator 140b.

In an embodiment, the wideband receiver in each of the receive-transmit laser modules converts an optical signal received from the respective output port of the optical switch matrix to an electronic signal. The fixed wavelength laser modulator then modulates a fixed wavelength laser beam with the electronic signal generated by the respective wideband receiver to produce an output optical signal at a fixed predetermined wavelength to be transmitted to the WDM optical network. Alternatively, the receive-transmit laser modules are capable of performing optical-to-optical wavelength conversions directly.

In an embodiment, the WDM optical switching node 110 further comprises a wavelength multiplexer 142 which has a multiple-wavelength port and a plurality of single-wavelength ports including a first plurality of single-wavelength ports 146a and 146b and a second plurality of single-wavelength ports 148a and 148b. In an embodiment, the first plurality of single-wavelength ports 146a and 146b are connected to the fixed wavelength laser modulators 140a and 140b of the receive-transmit laser modules 136a and 136b, respectively, to receive the modulated optical signals at wavelengths λ₁ and λ₂.

The second plurality of single-wavelength ports 148a and 148b of the wavelength multiplexer 142 are connected to the second plurality of input ports 126a and 126b, respectively, of the optical switch matrix 120. In an embodiment, a DWDM fiber interface 150 is connected to the multiple-wavelength port 144 of the wavelength multiplexer 142 to transport wavelength-multiplexed optical signals between the DWDM optical switching node 110 and other nodes in the DWDM optical network.

In the embodiment shown in FIG. 3, wavelengths λ₁ and λ₂ are assigned to carry information in an outbound direction from the IP routers to the DWDM optical network, while wavelengths λ₃ and λ₄ are assigned to carry information in an inbound direction from the DWDM optical network to the IP routers. However, because the optical switch matrix 120 is implemented in the optical switching node 110, each of the wavelengths λ₁ and λ₂ can be flexibly assigned to carry outbound traffic from a different IP router to the DWDM optical network. For example, wavelength λ₁ normally can be assigned to carry outbound traffic from the IP router 102 to the DWDM fiber interface 150.

However, if another IP router (not shown in FIG. 3), which is connected to another input optical interface, for example, the input optical interface 112b, already uses the wavelength λ₁ for outbound internet traffic, the IP router 102 can no longer use the same wavelength λ₁ for outbound internet traffic. In this scenario, the optical switch matrix 120 switches the optical path 116a carrying outbound internet traffic from the IP router 102 to the second receive-transmit laser module 136b, which is assigned the second wavelength λ₂, to communicate with the DWDM fiber interface 150.

In a similar manner, the inbound internet traffic from the second plurality of input ports 126a and 126b of the optical switch matrix 120 can be flexibly switched to the output optical interfaces 114a and 114b. For example, the IP router 102 in FIG. 3 is assigned to receive inbound internet traffic at wavelength λ₃ from the wideband receiver 130a. The inbound optical signals from the single-wavelength ports 148a and 148b of the wavelength multiplexer 142 are capable of being flexibly switched by the optical switch matrix 120 to either one of the output optical interfaces 114a and 114b. Therefore, the IP router 102 is capable of receiving signals in the inbound direction at wavelength λ₃ from either the input port 126a or the input port 126b of the optical switch matrix 120.

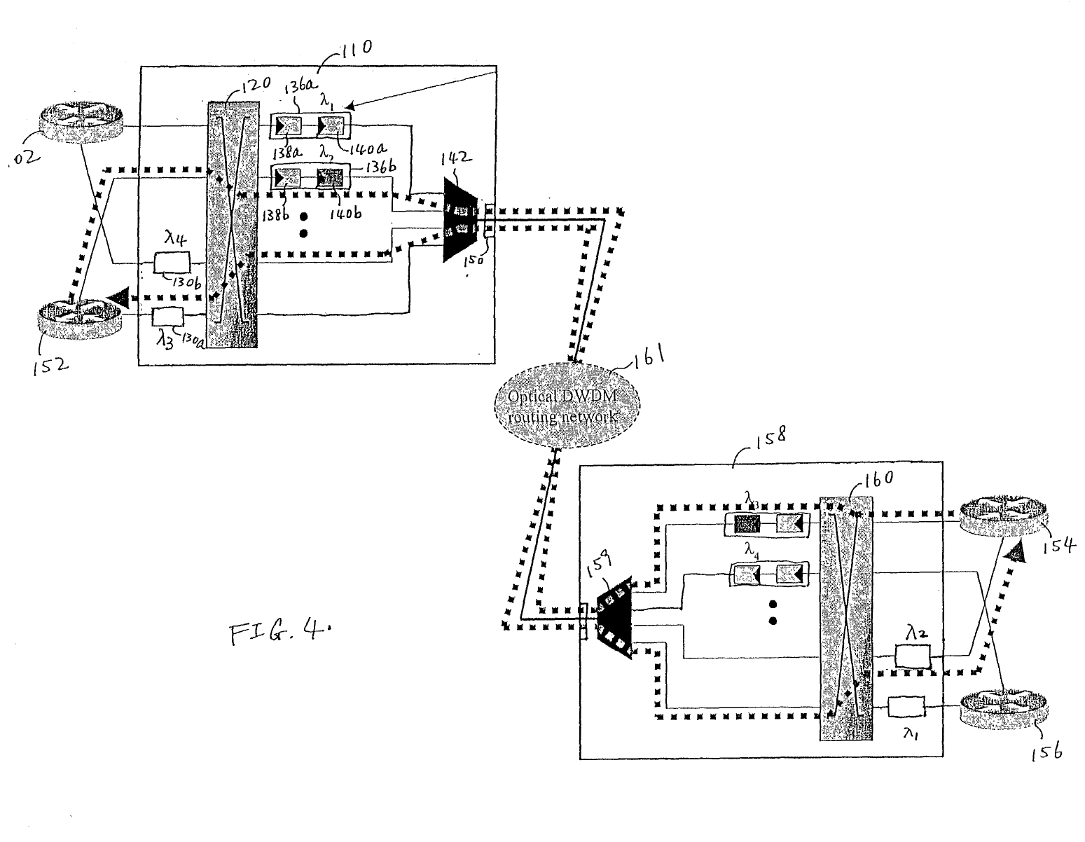

FIG. 4 shows a diagram of an optical DWDM network with two optical switching nodes of FIG. 3 with partial wavelength translation in an embodiment according to the present invention. In this embodiment, it is assumed that the transportation of internet data is half-duplex, that is, the data direction is either inbound or outbound in each optical channel. The optical switch matrix in each of the optical switching nodes is a wide-bandwidth switching fabric that is capable of switching both wideband laser inputs from the IP routers and WDM laser inputs from the DWDM optical network.

FIG. 4 shows two IP routers 102 and 152 connected to the first optical switching node 110 and two IP routers 154 and 156 connected to the second optical switching node 158, although additional IP routers may also be connected to each optical switching node in a different embodiment within the scope of the present invention. In the example shown in FIG. 4, the IP routers 152 and 102 are assigned to receive inbound internet traffic at optical wavelengths λ₃ and λ₄, respectively. On the opposite side of the DWDM optical network, the IP routers 156 and 154 are assigned to receive internet traffic in the inbound direction at wavelengths λ₁ and λ₂, respectively.

The outbound optical signals carrying internet data from the IP router 102 may be switched by the optical switch matrix 120 in the first optical switching node 110 to either λ₁ or λ₂ for transmission over the DWDM optical network. The outbound internet data from the IP router 102 may be received by either the IP router 154 or the IP router 156 depending upon the wavelength of the optical signal by which the outbound internet traffic from the IP router 102 is carried. For example, if the outbound traffic from the IP router 102 is switched by the optical switch matrix 120 to the receive-transmit laser module 136a, which is assigned wavelength λ₁, then the optical switch matrix 160 in the receiving optical switching node 158 switches the optical signal to the IP router 156. On the other hand, if the outbound internet traffic from the IP router 102 is switched to the optical path through the receive-transmit laser module 136b, which is assigned wavelength λ₂, then the IP router 154 receives the internet data from the IP router 102 in the inbound direction.

In the opposite direction, the outbound internet traffic from the IP router 154 or the IP router 156 can be assigned either λ₃ or λ₄ depending upon the desired destination, which is either the IP router 102 or the IP router 152 for receiving the internet traffic. For example, if the outbound internet traffic from the IP router 154 is switched to wavelength λ₃, then the IP router 152 receives the internet data from the IP router 154. Similarly, if the outbound internet traffic from the IP router 156 is switched to wavelength λ₄, then the IP router 102 receives the internet data from the IP router 156.

In the embodiments described above with respect to FIGS. 3 and 4, the number of wavelengths available to a network operator are divided between inbound and outbound directions of internet traffic between the IP routers to ensure bi-directional routing. For example, while the outbound traffic from the IP router 102 can be switched to either wavelength λ₁ or λ₂, depending upon whether that wavelength is available, it can only receive inbound traffic at wavelength λ₄. The wavelengths λ₁ and λ₂ can be used for outbound traffic from the IP routers 102 and 152, but not for inbound traffic to these routers.

Similarly, the wavelengths λ₃ and λ₄ can be used for outbound traffic from the IP routers 154 and 156, but not for inbound traffic to these routers. With partial wavelength translation, however, an IP router on one side of the DWDM optical network is capable of communicating with any one of the IP routers on the other side of the DWDM optical network, thereby greatly enhancing the flexibility of communications between IP routers on different sides of the DWDM optical network.

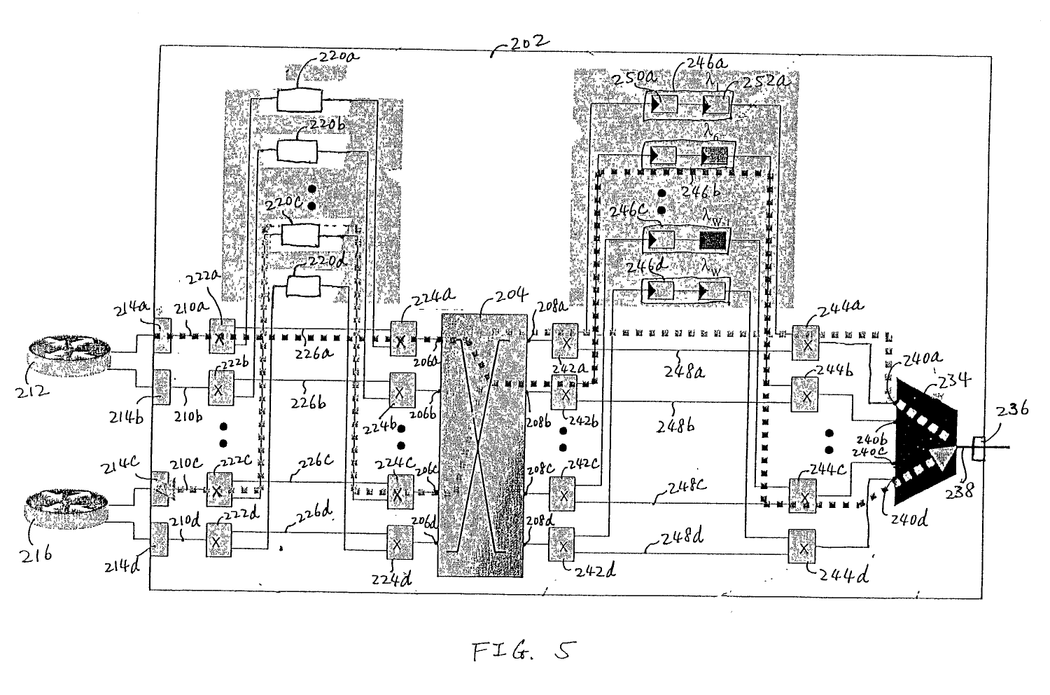

FIG. 5 shows an optical switching node 202 in an optical DWDM network with full wavelength translation in an embodiment according to the present invention. The optical switching node 202 comprises a W×W optical switch matrix 204 having a first plurality of ports including ports 206a, 206b, 206c and 206d and a second plurality of ports including ports 208a, 208b, 208c and 208d. The number W is the total number of wavelengths supported by the optical switching node 202. A first plurality of optical channels including optical channels 210a, 210b, 210c and 210d are provided in the optical switching node to transport wideband optical signals carrying internet traffic between IP routers and the optical switch matrix 204.

In FIG. 5, an IP router 212 is connected to the optical channels 210a and 210b through optical interfaces 214a and 214b, respectively. One of the optical channels 210a and 210b is assigned to carry inbound traffic for the IP router 212 while the other is assigned to carry outbound traffic for the IP router 212. In a similar manner, another IP router 216 is connected to the optical channels 210c and 210d through optical interfaces 214c and 214d, respectively. One of the optical channels 210c and 210d is assigned to carry outbound traffic for the IP router 216 while the other is assigned to carry the inbound traffic for the IP router 216. In an embodiment, the optical interfaces 214a, 214b, 214c and 214d are wideband ITU-T interfaces operating at wavelengths on the order of about 1310 nm.

In an embodiment, a plurality of wideband receivers including wideband receivers 220a, 220b, 220c and 220d are implemented in the optical switching node 202. A first plurality of 1×2 optical switches including pairs of optical switches 222a, 224a, 222b, 224b, 222c, 224c, and 222d, 224d are positioned between the respective optical channels 210a, 210b, 210c and 210d and the first plurality of ports 206a, 206b, 206c and 206d of the optical switch matrix, respectively. Each pair of 1×2 optical switches are capable of connecting the respective optical channel to the respective port of the optical switch matrix 204 either directly or through a respective receive-transmit laser module. In an embodiment, a plurality of optical fibers 226a, 226b, 226c and 226d are provided between the respective pairs of 1×2 optical switches for direct optical connections between the optical interfaces 214a, 214b, 214c and 214d and the first plurality of ports 206a, 206b, 206c and 206d of the optical switch matrix 204.

When one of the optical channels, for example, optical channel 210a, is used for inbound internet traffic to the IP router 212, the 1×2 optical switches 222a and 224a are switched to connect the optical channel 210a to the optical port 206a through the wideband receiver 220a. In a similar manner, another wideband receiver 220b is connected between the respective pair of 1×2 optical switches 222b and 224b for inbound internet traffic to the IP router 212. Furthermore, additional wideband receivers 220c and 220d are connected between the respective pairs of 1×2 optical switches 222c, 224c and 222d, 224d for inbound internet traffic to the IP router 216.

For each IP router, one of the optical channels receives inbound internet traffic while the other transmits outbound internet traffic. For example, for the IP router 212, if the optical channel 210a is switched to receive inbound traffic through the wideband receiver 220a, then the other optical channel 210b is switched to the optical fiber 226b to carry outbound traffic from the IP router 212 directly to the optical port 206b of the optical switch matrix 204.

A wavelength multiplexer 234 is provided in the optical switching node 202 to communicate with other optical switching nodes in the DWDM optical network through a DWDM fiber interface 236. The wavelength multiplexer has a multiple-wavelength port 238 and a plurality of single-wavelength ports 240a, 240b, 240c and 240d. A second plurality of 1×2 optical switches including pairs of 1×2 optical switches 242a, 244a, 242b, 244b, 242c, 244c and 242d, 244d are provided between the second plurality of ports 208a, 208b, 208c and 208d of the optical switch matrix 204 and the single-wavelength ports 240a, 240b, 240c, and 240d of the wavelength multiplexer 234, respectively.

A plurality of receive-transmit laser modules 246a, 246b, 246c and 246d and a plurality of optical fibers 248a, 248b, 248c and 248d are provided between respective pairs of 1×2 optical switches. Each pair of the 1×2 optical switches are capable of connecting a respective port of the optical switch matrix 204 to a respective single-wavelength port of the wavelength multiplexer 234 either through a respective optical fiber which provides a direct optical signal path or through a respective receive-transmit laser module. For example, the single-wavelength port 240a of the wavelength multiplexer 234 may be connected to the optical port 208a of the optical switch matrix 204 either through the optical fiber 248a or through the receive-transmit laser module 246a.

In an embodiment, the receive-transmit laser module 246a comprises a wideband receiver 250a and a fixed wavelength laser modulator 252a. The wideband receiver 250a converts the optical signal received from the optical port 208a of the optical switch matrix 204 to an electronic signal, which is used by the fixed wavelength laser modulator 252a to modulate a fixed wavelength laser to produce an output signal. In a similar manner, each of the receive-transmit laser modules 246b, 246c and 246d also comprises a wideband receiver and a fixed wavelength laser modulator. The receive-transmit laser modules 246a, 246b, 246c and 246d are each assigned a predetermined wavelength for communications with the optical network. The receive-transmit laser modules 246a, 246b, 246c and 246d are used for outbound traffic from the IP routers such as IP routers 212 and 216, whereas direct optical paths provided by the optical fibers 248a, 248b, 248c and 248d are used for inbound traffic to the IP routers.

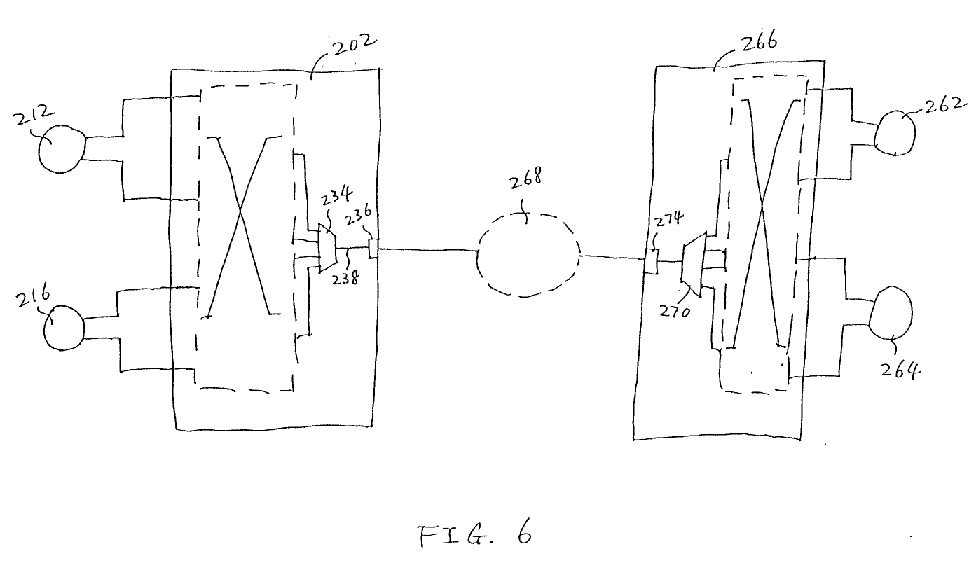

FIG. 6 shows an embodiment of a DWDM optical network with two optical switching nodes of FIG. 5 connected to each other for communications between multiple IP routers on opposite sides of the network. In FIG. 6, two IP routers 212 and 216 are connected to the first optical switching node 202, while two IP routers 262 and 264 are connected to a second optical switching node 266. The multiple-wavelength ports of the wavelength multiplexer 234 in the first optical switching node 202 and the wavelength multiplexer 270 in the second optical switching node 266 are connected to the DWDM optical wavelength routing network 268 through DWDM fiber interfaces 236 and 274. The wavelength routing network 268, which is connected to a plurality of optical switching nodes with full wavelength translation, allows each of the wavelengths to be dynamically assigned to any one of the IP routers for either inbound or outbound traffic. Although FIG. 6 shows two IP routers connected to each optical switching node, additional IP routers may be implemented on both sides of the optical network within the scope of the present invention. Furthermore, additional optical switching nodes may also be connected to the optical wavelength routing network 268 within the scope of the present invention.

The present invention has been described with respect to particular embodiments thereof, and numerous modifications can be made which are within the scope of the invention as set forth in the claims.

What is claimed is:

1. An optical switching system, comprising:
a plurality of input optical channels capable of receiving optical signals carrying internet traffic;
a plurality of output optical channels capable of transmitting optical signals carrying internet traffic;
an optical switch matrix having first and second pluralities of input ports and first and second pluralities of output ports, the first plurality of input ports connected to the input optical channels, the first plurality of output ports connected to the output optical channels;
a plurality of fixed wavelength laser modulators connected to the second plurality of output ports of the optical switch matrix; and
a wavelength multiplexer having a multiple-wavelength port and first and second pluralities of single-wavelength ports, the first plurality of single-wavelength ports connected to the second plurality of fixed wavelength laser modulators, the second plurality of single-wavelength ports connected to the second plurality of input ports of the optical switch matrix.

2. The system of claim 1, further comprising:
a plurality of input optical interfaces connected to the input optical channels; and
a plurality of output optical interfaces connected to the output optical channels.

3. The system of claim 2, further comprising an internet protocol (IP) router having an output port connected to a predetermined one of the input optical interfaces and an input port connected to a predetermined one of the output optical interfaces.

4. The system of claim 1, further comprising a plurality of outbound wideband receivers connected between the second plurality of output ports of the optical switch matrix and the fixed wavelength laser modulators.

5. The system of claim 4, wherein the outbound wideband receivers are capable of converting optical signals received from the second plurality of output ports of the optical switch matrix to electronic signals.

6. The system of claim 5, wherein the fixed wavelength laser modulators are capable of modulating fixed wavelength laser beams with the electronic signals to generate output single-wavelength optical signals transmitted to the first plurality of single-wavelength ports of the wavelength multiplexer.

7. The system of claim 1, further comprising a plurality of inbound wideband receivers connected to the first plurality of output ports of the optical switch matrix.

8. The system of claim 7, wherein the inbound wideband receivers are capable of converting optical signals received from the first plurality of output ports of the optical switch matrix to electronic signals.

9. The system of claim 7, wherein the inbound wideband receivers are capable of performing optical wavelength conversions.

10. The system of claim 7, further comprising a plurality of internet protocol (IP) routers each having an input connected to a respective one of the inbound wideband receivers.

11. An optical switching system, comprising:
a plurality of input optical channels capable of receiving optical signals carrying internet traffic;
a plurality of output optical channels capable of transmitting optical signals carrying internet traffic;
an optical switch matrix having first and second pluralities of input ports and first and second pluralities of output ports, the first plurality of input ports connected to the input optical channels, the first plurality of output ports connected to the output optical channels;
a plurality of receive-transmit laser modules connected to the second plurality of output ports of the optical switch matrix; and
a wavelength multiplexer having a multiple-wavelength port and first and second pluralities of single-wavelength ports, the first plurality of single-wavelength ports connected to the outbound receive-transmit laser modules, the second plurality of single-wavelength ports connected to the second plurality of input ports of the optical switch matrix.

12. The system of claim 11, further comprising:
a plurality of input optical interfaces connected to the input optical channels; and
a plurality of output optical interfaces connected to the output optical channels.

13. The system of claim 12, further comprising an internet protocol (IP) router having an output port connected to a predetermined one of the input optical interfaces and an input port connected to a predetermined one of the output optical interfaces.

14. The system of claim 11, wherein the receive-transmit laser modules each comprise an outbound wideband receiver connected to a respective one of the second plurality of output ports of the optical switch matrix and a fixed wavelength laser modulator connected to the outbound wideband receiver.

15. The system of claim 14, wherein the outbound wideband receiver in each of the receive-transmit laser modules is capable of converting an optical signal received from said respective one of the second plurality of output ports of the optical switch matrix to an electronic signal.

16. The system of claim 15, wherein the fixed wavelength laser modulator in each of the receive-transmit laser modules is capable of modulating a fixed wavelength laser beam with the electronic signal to generate an output single-wavelength optical signal transmitted to a respective one of the first plurality of single-wavelength ports of the wavelength multiplexer.

17. The system of claim 11, further comprising a plurality of inbound wideband receivers each connected to a respective one of the first plurality of output ports of the optical switch matrix.

18. The system of claim 17, wherein each of the inbound wideband receivers is capable of converting an optical signal received from said respective one of the first plurality of output ports of the optical switch matrix to an electronic signal.

19. The system of claim 17, wherein the inbound wideband receives are capable of performing optical wavelength conversions.

20. An optical switching system, comprising:
a plurality of internet protocol (IP) routers each having an input port and an output port;
a plurality of input optical channels each connected to the output port of a respective one of the IP routers;
a plurality of inbound wideband receivers each connected to the input port of a respective one of the IP routers;
an optical switch matrix having first and second pluralities of input ports and first and second pluralities of output ports, the first plurality of input ports connected to the input optical channels, the first plurality of output ports connected to the inbound wideband receivers;
a plurality of receive-transmit laser modules connected to the second plurality of output ports of the optical switch matrix; and
a wavelength multiplexer having a multiple-wavelength port and first and second pluralities of single-wavelength ports, the first plurality of single-wavelength ports connected to the receive-transmit laser modules, the second plurality of single-wavelength ports connected to the second plurality of input ports of the optical switch matrix.

21. The system of claim 20, wherein the receive-transmit laser modules each comprise an outbound wideband receiver connected to a respective one of the second plurality of output ports of the optical switch matrix and a fixed wavelength laser modulator connected to the outbound wideband receiver.

22. The system of claim 21, wherein the outbound wideband receiver in each of the receive-transmit laser modules is capable of converting an optical signal received from said respective one of the second plurality of output ports of the optical switch matrix to an electronic signal.

23. The system of claim 22, wherein the fixed wavelength laser modulator in each of the receive-transmit laser modules is capable of modulating a fixed wavelength laser beam with the electronic signal to generate an output single-wavelength optical signal transmitted to a respective one of the first plurality of single-wavelength ports of the wavelength multiplexer.

24. The system of claim 20, wherein the receive-transmit laser modules are capable of performing optical wavelength conversions.

25. The system of claim 20, wherein each of the inbound wideband receivers is capable of converting an optical signal received from said respective one of the first plurality of output ports of the optical switch matrix to an electronic signal.

26. The system of claim 25, wherein the inbound wideband receivers are capable of performing optical wavelength conversions.

27. An optical switching system, comprising:
a first plurality of optical channels capable of transporting optical signals carrying internet traffic;
a plurality of inbound wideband receivers;
an optical switch matrix having first and second pluralities of ports;
a first plurality of optical switches capable of connecting the first plurality of ports of the optical switch matrix to the first plurality of optical channels respectively through the inbound wideband receivers;
a second plurality of optical channels capable of transporting optical signals carrying internet traffic;
a plurality of fixed wavelength laser modulators;
a second plurality of optical switches capable of connecting the second plurality of ports of the optical switch matrix to the second plurality of optical channels respectively through the fixed wavelength laser modulators; and
a wavelength multiplexer having a multiple-wavelength port and a plurality of single-wavelength ports, the single-wavelength ports connected to the second plurality of optical channels.

28. The system of claim 27, further comprising a plurality of optical interfaces connected to the first plurality of optical channels and at least one internet protocol (IP) router having input and output ports connected to predetermined ones of the optical interfaces.

29. The system of claim 27, wherein the inbound wideband receivers are connected to said at least one IP router for inbound internet traffic.

30. The system of claim 29, wherein the inbound wideband receivers are capable of converting optical signals received from the first plurality of ports of the optical switch matrix to electronic signals.

31. The system of claim 30, wherein the inbound wideband receivers are capable of performing optical wavelength conversions.

32. The system of claim 27, further comprising a plurality of outbound wideband receivers connected to the fixed wavelength laser modulators.

33. The system of claim 32, wherein the outbound wideband receivers are capable of converting optical signals received from the second plurality of ports of the optical switch matrix to electronic signals.

34. The system of claim 33, wherein the fixed wavelength laser modulators are capable of modulating fixed wavelength laser beams with the electronic signals to generate output single-wavelength optical signals to be transmitted to the second plurality of optical channels.

35. The system of claim 27, wherein the first plurality of optical switches comprise a plurality of pairs of 1×2 optical switches.

36. The system of claim 35, further comprising a plurality of optical fibers each positioned between a respective pair of the 1×2 optical switches, each pair of the 1×2 optical switches capable of connecting a respective one of the first plurality of ports of the optical switch matrix to a respective one of the first plurality of optical channels either through a respective one of the optical fibers or through a respective one of the inbound wideband receivers.

37. The system of claim 27, wherein the second plurality of optical switches comprise a plurality of pairs of 1×2 optical switches.

38. The system of claim 37, further comprising a plurality of optical fibers each positioned between a respective pair of the 1×2 optical switches, each pair of the 1×2 optical switches capable of connecting a respective one of the second plurality of ports of the optical switch matrix to a respective one of the second plurality of optical channels either through a respective one of the optical fibers or through a respective one of the fixed wavelength laser modulators.

39. An optical switching system, comprising:
a first plurality of optical channels capable of transporting optical signals carrying internet traffic;
a plurality of inbound wideband receivers;
an optical switch matrix having first and second pluralities of ports;
a first plurality of optical switches capable of connecting the first plurality of ports of the optical switch matrix to the first plurality of optical channels respectively through the inbound wideband receivers;
a second plurality of optical channels capable of transporting optical signals carrying internet traffic;
a plurality of receive-transmit laser modules;
a second plurality of optical switches capable of connecting the second plurality of ports of the optical switch matrix to the second plurality of optical channels respectively through the receive-transmit laser modules; and
a wavelength multiplexer having a multiple-wavelength port and a plurality of single-wavelength ports, the single-wavelength ports connected to the second plurality of optical channels.

40. The system of claim 39, further comprising a plurality of optical interfaces connected to the first plurality of optical channels and at least one internet protocol (IP) router having input and output ports connected to predetermined ones of the optical interfaces.

41. The system of claim 40, wherein at least one of the inbound wideband receivers is connected to said at least one IP router for inbound internet traffic.

42. The system of claim 39, wherein the receive-transmit laser modules each comprise an outbound wideband receiver and a fixed wavelength laser modulator connected to the outbound wideband receiver.

43. The system of claim 39, wherein the first plurality of optical switches comprise a plurality of pairs of 1×2 optical switches.

44. The system of claim 43, further comprising a plurality of optical fibers each positioned between a respective pair of the 1×2 optical switches, each pair of the 1×2 optical switches capable of connecting a respective one of the first plurality of ports of the optical switch matrix to a respective one of the first plurality of optical channels either through a respective one of the optical fibers or through a respective one of the inbound wideband receivers.

45. The system of claim 39, wherein the second plurality of optical switches comprise a plurality of pairs of 1×2 optical switches.

46. The system of claim 45, further comprising a plurality of optical fibers each positioned between a respective pair of the 1×2 optical switches, each pair of the 1×2 optical switches capable of connecting a respective one of the second plurality of ports of the optical switch matrix to a respective one of the second plurality of optical channels either through a respective one of the optical fibers or through a respective one of the receive-transmit laser modules.

47. An optical switching system, comprising:
a plurality of internet protocol (IP) routers;
a first plurality of optical channels connected to the IP routers to transport wideband optical signals carrying internet traffic;
a plurality of inbound wideband receivers;
an optical switch matrix having first and second pluralities of ports;
a first plurality of optical switches capable of connecting the first plurality of ports of the optical switch matrix to the first plurality of optical channels respectively through the inbound wideband receivers;
a second plurality of optical channels capable of transporting single-wavelength optical signals;
a plurality of receive-transmit laser modules;
a second plurality of optical switches capable of connecting the second plurality of ports of the optical switch matrix to the second plurality of optical channels respectively through the receive-transmit laser modules; and
a wavelength multiplexer having a multiple-wavelength port and a plurality of single-wavelength ports, the single-wavelength ports connected to the second plurality of optical channels.

48. The system of claim 47, wherein at least one of the inbound wideband receivers is connected to at least one of the IP routers for inbound internet traffic.

49. The system of claim 47, wherein the receive-transmit laser modules each comprise an outbound wideband receiver and a fixed wavelength laser modulator connected to the outbound wideband receiver.

50. The system of claim 47, wherein the first plurality of optical switches comprise a plurality of pairs of 1×2 optical switches.

51. The system of claim 50, further comprising a plurality of optical fibers each positioned between a respective pair of the 1×2 optical switches, each pair of the 1×2 optical switches capable of connecting a respective one of the first plurality of ports of the optical switch matrix to a respective one of the first plurality of optical channels either through a respective one of the optical fibers or through a respective one of the inbound wideband receivers.

52. The system of claim 47, wherein the second plurality of optical switches comprise a plurality of pairs of 1×2 optical switches.

53. The system of claim 52, further comprising a plurality of optical fibers each positioned between a respective pair of the 1×2 optical switches, each pair of the 1×2 optical switches capable of connecting a respective one of the second plurality of ports of the optical switch matrix to a respective one of the second plurality of optical channels either through a respective one of the optical fibers or through a respective one of the receive-transmit laser modules.

54. An optical network, comprising:
first and second optical switching nodes in communication with each other, each of the optical switching nodes comprising:
a plurality of input optical channels capable of receiving optical signals carrying internet traffic;
a plurality of output optical channels capable of transmitting optical signals carrying internet traffic;
a plurality of inbound wideband receivers disposed along the output optical channels;
an optical switch matrix having first and second pluralities of input ports and first and second pluralities of output ports, the first plurality of input ports connected to the input optical channels, the first plurality of output ports connected to the output optical channels;
a plurality of fixed wavelength laser modulators connected to the second plurality of output ports of the optical switch matrix; and
a wavelength multiplexer having a multiple-wavelength port and first and second pluralities of single-wavelength ports, the first plurality of single-wavelength ports connected to the fixed wavelength laser modulators, the second plurality of single-wavelength ports connected to the second plurality of input ports of the optical switch matrix,
wherein the multiple-wavelength ports of the wavelength multiplexers in the first and second optical switching nodes are connected to each other.

55. The optical network of claim 54, further comprising a plurality of internet protocol (IP) routers connected to the first and second optical switching nodes.

56. The optical network of claim 54, further comprising a plurality of outbound wideband receivers connected between the fixed wavelength laser modulators and the second plurality of output ports of the optical switch matrix.

57. An optical network, comprising:
first and second optical switching nodes in communication with each other, each of the optical switching nodes comprising:
a plurality of input optical channels capable of receiving optical signals carrying internet traffic;
a plurality of output optical channels capable of transmitting optical signals carrying internet traffic;
a plurality of inbound wideband receivers disposed along the output optical channels;
an optical switch matrix having first and second pluralities of input ports and first and second pluralities of output ports, the first plurality of input ports connected to the input optical channels, the first plurality of output ports connected to the output optical channels;
a plurality of receive-transmit laser modules connected to the second plurality of output ports of the optical switch matrix; and
a wavelength multiplexer having a multiple-wavelength port and first and second pluralities of single-wavelength ports, the first plurality of single-wavelength ports connected to the receive-transmit laser modules, the second plurality of single-wavelength ports connected to the second plurality of input ports of the optical switch matrix,
wherein the multiple-wavelength ports of the wavelength multiplexers in the first and second optical switching nodes are connected to each other.

58. The optical network of claim 57, further comprising a plurality of internet protocol (IP) routers connected to the first and second optical switching nodes.

59. The optical network of claim 57, wherein the receive-transmit laser modules each comprise an outbound wideband receiver and a fixed wavelength laser modulator connected to the outbound wideband receiver.

60. An optical network, comprising:
first and second optical switching nodes in communication with each other, each of the first and second optical switching nodes comprising:
a first plurality of optical channels capable of transporting wideband optical signals carrying internet traffic;
a plurality of inbound wideband receivers;
an optical switch matrix having first and second pluralities of ports;
a first plurality of optical switches capable of connecting a respective one of the first plurality of ports of the optical switch matrix to a respective one of the first plurality of optical channels either directly or through a respective one of the inbound wideband receivers;
a second plurality of optical channels capable of transporting single-wavelength optical signals;
a plurality of fixed wavelength laser modulators;
a second plurality of optical switches capable of connecting a respective one of the second plurality of ports of the optical switch matrix to a respective one of the second plurality of optical channels either directly or through a respective one of the fixed wavelength laser modulators; and
a wavelength multiplexer having a multiple-wavelength port and a plurality of single-wavelength ports, the single-wavelength ports connected to the second plurality of optical channels,
wherein the multiple-wavelength ports of the wavelength multiplexers in the first and second optical switching nodes are connected to each other.

61. The optical network of claim 60, further comprising a plurality of internet protocol (IP) routers connected to the first and second optical switching nodes.

62. The optical network of claim 60, further comprising a plurality of outbound wideband receivers connected to the fixed wavelength laser modulators.

63. An optical network, comprising:
first and second optical switching nodes in communication with each other, each of the first and second optical switching nodes comprising:
a first plurality of optical channels capable of transporting wideband optical signals carrying internet traffic;
a plurality of inbound wideband receivers;
an optical switch matrix having first and second pluralities of ports;
a first plurality of optical switches capable of connecting a respective one of the first plurality of ports of the optical switch matrix to a respective one of the first plurality of optical channels either directly or through a respective one of the inbound wideband receivers;
a second plurality of optical channels capable of transporting single-wavelength optical signals;
a plurality of receive-transmit laser modules;
a second plurality of optical switches capable of connecting a respective one of the second plurality of ports of the optical switch matrix to a respective one of the second plurality of optical channels either directly or through a respective one of the receive-transmit laser modules; and
a wavelength multiplexer having a multiple-wavelength port and a plurality of single-wavelength ports, the single-wavelength ports connected to the second plurality of optical channels,
wherein the multiple-wavelength ports of the wavelength multiplexers in the first and second optical switching nodes are connected to each other.

64. The optical network of claim 63, further comprising a plurality of internet protocol (IP) routers connected to the first and second optical switching nodes.

65. The optical network of claim 63, wherein the receive-transmit laser modules each comprise an outbound wideband receiver and a fixed wavelength laser modulator connected to the outbound wideband receiver.
